(19) United States
(12) Patent Application Publication
(10) Pub. No.: US 2017/0127311 A1
(43) Pub. Date: May 4, 2017

(54) SYSTEMS AND METHODS FOR AUGMENTED NETWORK ANALYSIS

(71) Applicant: Root Wireless, Inc., Bellevue, WA (US)

(72) Inventors: Brian C. Webb, Maple Valley, WA (US); Ted Chou, Sammamish, WA (US)

(21) Appl. No.: 15/337,842

(22) Filed: Oct. 28, 2016

Related U.S. Application Data
(60) Provisional application No. 62/249,006, filed on Oct. 30, 2015.

(51) Int. Cl. H04W 28/02; H04L 12/26; H04L 12/859; H04L 12/24

(52) U.S. Cl. CPC H04W 28/0226; H04L 41/142; H04L 43/0888; H04L 47/2475

(57) ABSTRACT

Certain embodiments of the present disclosure are directed to methods, devices, systems, mobile devices, applications, and servers that measure or utilize measurements for quality of service of wireless communication networks by measuring a variety of real-world data transfer speeds. Certain embodiments of the present disclosure include a data-use-measuring application that can carry out data transfer rate measurements without impacting (or minimally impacting) a consumer's data usage.

This application claims the benefit of U.S. Provisional Patent Application No. 62/249,006, filed on Oct. 30, 2015, and entitled Systems and Methods for Augmented Network Analysis. The contents of that application are incorporated by reference herein for all purposes.

### BACKGROUND

Consumers use mobile devices for a wide variety of purposes, including voice communications and data communications like texting, navigation, e-mailing, and streaming music and videos. Data communications typically involve transferring data from a server over a wireless communications network to a mobile device for consumption. Generally, consumers pay a monthly fee in return for wireless communication services set for a specific amount of voice and data communication usage. Providers compete on price, geographic availability of service, and quality of service, among other things.

Quality of service for data communications primarily depends on available data transfer speeds. One method of analyzing quality of service involves measuring maximum data transfer speeds. Measuring maximum data transfer speeds can include over-saturating communications channels (e.g., maximizing data transfers to a mobile device) at various locations, but that approach uses a lot of data. Moreover, maximum data transfer speeds can vary at a given location depending on the time of day. For example, in the early morning when relatively few consumers are transferring data to their mobile devices, maximum available data transfer speeds may be quite large compared to maximum speeds during the afternoon. Maximum data transfer speeds also are not necessarily consistent with how consumers actually use mobile devices to consume data. Accordingly, certain embodiments of the present disclosure are directed to methods, devices, systems, mobile devices, applications, and servers that measure or utilize measurements for quality of service of wireless communication networks by measuring a variety of real-world data transfer speeds.

### SUMMARY

Certain embodiments of the present disclosure include a system for identifying data speeds of a wireless communications network as observed by mobile devices provisioned for typical use on the wireless communications networks. The system can include a server configured to receive location information of a mobile device, receive data transfer speed information associated with a plurality of applications of the mobile device, and in response to receiving the location and data transfer speed information, determine a type of data activity that can be serviced at the location. The system can further include a mobile device provisioned for typical use on the wireless communications network. The mobile device can be configured to generate the location information and the data transfer speed information and to send the generated information to the server. The mobile device can include a data-transfer-measuring application and a plurality of applications that consume data at a data transfer speed when data is transferred to the mobile device over the wireless communications network. The data-transfer-measuring application is configured to measure data usage of the plurality of applications without initiating a transfer of data to the mobile device. The system can further include a plurality of mobile devices each generating location information and associated data transfer speed information. The server may be configured to receive location information and associated data transfer speed information from the plurality of mobile devices. Further yet, the server may generate a visual indicator of the received data transfer speeds.

Certain embodiments of the present disclosure include a method that receives data from a plurality of applications operating in the foreground of a mobile device that is provisioned for typical use on a wireless communications network. The method further includes monitoring data usage rates of the plurality of application by using a second application on the mobile device that is separate from the plurality of applications and that runs in the background of the mobile device. The method can include reading a first total data usage value at a first time and reading a second total data usage value a second time. A timing interval is calculated by subtracting the first time from the second time. A data-usage difference is calculated by subtracting the first total usage value from the second total usage value. The data usage rate is calculating by dividing the data usage difference by the timing interval. In certain embodiments, the timing interval is set in response to detecting data usage. For example, a shorter timing interval can be used in response to detecting data usage while a longer timing interval can be used in response to detecting no data usage. The method can further include storing data usage rates in the mobile device's memory. The second application can receive data usage rates without initiating a transfer of data to a mobile device on which the plurality of applications and the second application are stored.

Certain embodiments of the present disclosure include a mobile device that includes a plurality of data-use applications that receive data at a data transfer speed and a data-use-measuring application. The data-use-measuring application is configured to measure data transfer speeds of the plurality of data-use applications without initiating a transfer of data to the mobile device. The data-use-measuring application can be configured to receive information associated with a location of the mobile device. The data-use-measuring application can be further configured to receive information associated with a type of application being used and related data usage rates of the application. Further yet, the data-use-measuring application can be configured to store the location information, data usage information, and type of application in memory. The data-use-measuring application can be configured to transmit at least one of the following to a server: the location information, the data usage information, the type of application being used (e.g., music application, video application, social application, and e-mail application) information, operating system version information, mobile device model information, network carrier information, and network version information.

Certain embodiments of the present disclosure include a system having a mobile device including a plurality of applications and a data-use-measuring application, wherein the data-use-measuring application is configured to measure data transfer speeds of the plurality of data-use applications without initiating a transfer of data to the mobile device. The system further includes a server configured to receive the data transfer speeds measured by the data-use-measuring application. The data-use-measuring application is configured to receive information associated with a location of the mobile device. The server is configured to generate a map of data usage rates in response to the received data transfer speeds and the location information

Certain embodiments of the present disclosure include a method for analyzing performance of a wireless communication network. The method includes receiving location information indicative of a geographical location of a mobile device. The method further includes measuring data transfer speeds of each of the mobile device's plurality of applications. In response to the receive location information and measured data transfer speeds, the method determines a type of data transfer activity that can be supported by the wireless communication network at the geographical location.

Certain embodiments of the present disclosure include a mobile device having a graphical user interface with an image of a geographical region and a visual representation of data transfer speeds measured from a plurality of applications used on mobile devices located within the geographical region.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 provides a schematic of a wireless communications system, in accordance with certain embodiments of the present disclosure.

FIG. 2 provides a schematic of a mobile device, in accordance with certain embodiments of the present disclosure.

FIG. 3 provides an example of a data communications map, in accordance with certain embodiments of the present disclosure.

FIG. 4 provides an example portion of a data communications map, in accordance with certain embodiments of the present disclosure.

FIG. 5 provides an example of a data communications map utilizing concepts shown in FIG. 4, in accordance with certain embodiments of the present disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

As previously mentioned, consumers use mobile devices for a wide range of purposes—each of which may utilize different mobile-device-installed applications and require different data transfer speeds to provide acceptable levels of service. For example, e-mail applications may only need ˜10 kilobytes/second to function effectively while music streaming applications may use 2-5 megabytes/second and high-definition-video streaming applications 7 megabytes/second or more for acceptable levels of service. Certain embodiments of the present disclosure contemplate tracking an individual mobile device's actual data transfer speeds (e.g., usage rates) for eventual use in analyzing and comparing wireless networks' performance and capabilities. For example, a mobile device can be provisioned with a data-use-measuring application that measures how much data the mobile device is using. This could include measuring how much data is being used on an application-by-application basis. The measuring application may determine a general type of application being used (e.g., music streaming, video streaming) or a specific application being used (e.g., Netflix, Hulu, Pandora) and associate how fast and how much data is being transferred to the mobile device on an application-by-application basis. Because mobile devices typically include components and software (e.g., global positioning system) that determine a device's location, the measuring application can also associate location information of the mobile device with the measured data transfer speeds. For example, the data-use-measuring application may determine what data transfer speeds are being consumed at a given location when the mobile device is streaming video through one application and streaming music through another application.

The measuring application can then store the location and data-transfer information, among other types of information, in the mobile device's memory and transmit the information to a server. The server can be configured to receive such information from a plurality of mobile devices provisioned with data-use-measuring applications. Measured information can then be combined by the server to determine data communication network performance. Specifically, based on real-world data use (e.g., measured data transfer speeds from mobile devices provisioned for typical use on a wireless communications network) the server can determine, for a given location, an expected quality of service for the data communication network being used. The server's results can then be used by consumers to determine, for example, what types of activities typically can be completed at a given location. As will be discussed in more detail below, the server's resulting calculations can be presented within a map. Consumers can use the map, for example, to determine whether their wireless carrier's data communications network in a specific area near Bellevue, Washington will support streaming music, receiving e-mail, or streaming high-definition video.

As previously mentioned, consumers typically pay a monthly fee for a mobile device data communications plan that has a set maximum amount of data that is to be consumed by the mobile device. Accordingly, certain embodiments of the present disclosure include a data-use-measuring application that can carry out data transfer rate measurements without impacting (or minimally impacting) a consumer's data usage. For example, the data-use-measuring application can determine through a mobile device's application programming interface (API) how much data is being transferred. Using this or similar approaches, the measuring application itself won't initiate a data transfer or consume data during the measuring process. The measuring application can store the measured information in a mobile device's memory for eventual transfer to a server. The stored information can then be periodically bundled together and sent to the server with minimal data usage (or no data usage if information is transferred while the mobile device is connected to a Wi-Fi network).

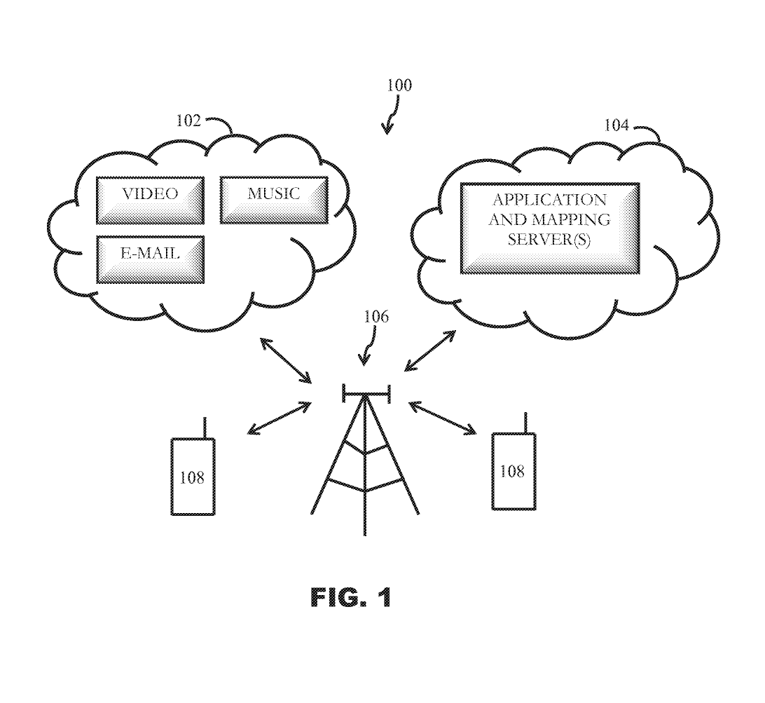

FIG. 1 shows an example wireless communications network 100 including an array of servers 102, set of application and mapping servers 104, wireless transmitter 106, and mobile devices 108 all in wireless communication with each other. The array of servers 102 includes servers that store data like music, movies, and e-mail and transmit such data over the wireless network 100 to and from mobile devices 108 for streaming or downloading. The application and mapping servers 104, which will be described in greater detail below, receive location and data transfer speed information from mobile devices 108 for use in determining carriers' wireless network performance and capabilities.

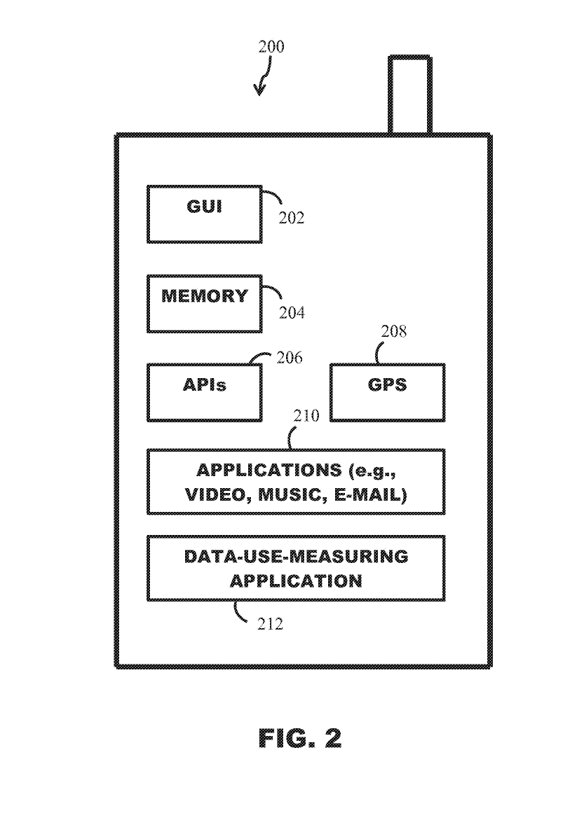

FIG. 2 shows a mobile device 200 that may be used in the wireless network shown in FIG. 1. The mobile device 200 includes a graphical user interface 202 (GUI), memory 204, application programming interfaces (APIs) 206, global positioning system (GPS) components 208, applications 210 for accessing various types of content like music and video, and a data-use-measuring application 212.

Consumers typically access data with their mobile device through applications 210 downloaded to the mobile device. Applications 210 may be programmed to access a certain type of content like video (e.g., Neflix), music (e.g., Pandora), social media posts (e.g., Twitter) via the wireless network 100. Different types of content consume data at different data transfer rates over a wireless network. For example, a social media application may consume ˜10 kilobytes/second while a music streaming application might consume 2-5 megabytes/second.

The data-use-measuring application 212 is configured to monitor, collect, and aggregate information related to data usage. For example, the measuring application 212 can read, at various predetermined timing intervals, the total amount of data (e.g., bytes) transferred to the mobile device 200 and calculate the difference between the readings. The difference can be divided by the predetermined timing interval to determine a data transfer speed. For example, if the data-use-measuring application 212 read a difference of the total amount of data transferred to the mobile device to be 4 megabytes within a 2-second timing internal, the data transfer speed would be calculated to be 2 megabytes per second. In certain embodiments, the measuring application 212 can have at least two different predetermined timing intervals. For example, one timing interval can be set at 1 second and the other interval set for 5seconds. A shorter timing interval can lead to increased power usage and shorter battery life. As such, the measuring application 212 may actively switch between shorter and longer timing intervals. For example, if the measuring application 212 continues to detect that the mobile device 200 is using data, the measuring application 212 may continue to apply a shorter timing interval. But if data usage is not detected for a set time period, the measuring application 212 may switch to a longer timing interval to conserve power. Other power-saving approaches can include completely turning off the measuring application 212 if no data transfer is detected and the mobile device's display is turned off or if the mobile device is running low on battery power. Another approach includes measuring data transfer speeds only after detecting that the mobile device has moved to a different geographical location.

At least one of the APIs 206 can be configured to track the mobile device's data usage. The measuring application 212 can utilize an API 206 to measure a mobile device's data usage without the application 212 initiating or using data itself. This approach mitigates an amount of data used by the data-use-measuring application 212. The measuring application 212 can associate measured data transfer speeds with individual applications and application types. For example, the measuring application 212 can track whether general (e.g., music streaming, video streaming) or specific (e.g., Netflix, Hulu, Pandora) types of application are being used by reading data from a mobile device's file system and associate data transfer speeds on an application-by-application basis. The measured and tracked information can be aggregated and stored to the mobile device's memory 204. The data-use-measuring application 212 can also receive and store to memory 204 information about the mobile device's location via GPS components 208. The measuring application 212 can run in the background of the mobile device 200 so as to not affect the mobile device's performance. Using this approach, the application 212 would not be visible through the GUI 202.

For privacy, personal information about a mobile device's owner or user could be excluded from data measuring or tracking, making use of the measuring application anonymous. The measuring application 212 can track and transmit other types of information about the mobile deice 200 and wireless network 100 such as information related to operating system version, model of mobile device, carrier, type of network, and the like. This information can be used to further characterize or associate with the measured data transfer speeds.

The measuring application 212 is configured to periodically transmit the location and data transfer speed information, among other types of information, to a server—like the application and mapping servers 104 shown in FIG. 1. Power and data use can be mitigated during data transmission by using a variety of approaches. One approach involves transmitting data only in certain locations and infrequently to minimize overall data usage and power consumption of the mobile device. By reducing the data transfer locations and frequency, data usage and power usage is reduced and correspondingly, a user's perception that software is detrimentally affecting the power usage of the mobile device is reduced. Another approach involves waiting to transmit data until the mobile device is plugged into a power source. Another approach involves periodically bundling information from the measuring application together with data packets from other applications and transmitting such information to the server with minimal extra data usage. Yet another approach involves transmitting information from the measuring application to the server when the mobile device is connected to a Wi-Fi network or other networks that do not count against a mobile device's monthly data usage plan. Further methods for reducing power and data usage are described in columns 9-18 of U.S. Pat. No. 8,160,571, which are hereby incorporated by reference.

The mapping server 104 is configured to receive location and data-transfer-speed information from a plurality of mobile devices provisioned with data-use-measuring applications. The information can then be aggregated, parsed, and analyzed by the server 104 to determine data communication network performance. For example, based on real-world data use (e.g., measured data transfer speeds from mobile devices provisioned for typical use on a wireless communications network) gathered from mobile devices, the server can determine, for a given location, an expected quality of service for the data communication network being used. Because maps are based on actual data transfer, at least one mobile device and preferably several need to actually consume data at a given location to be able to characterize performance of a data communications network at the location. The server's aggregated results can then be used to generate and update a map.

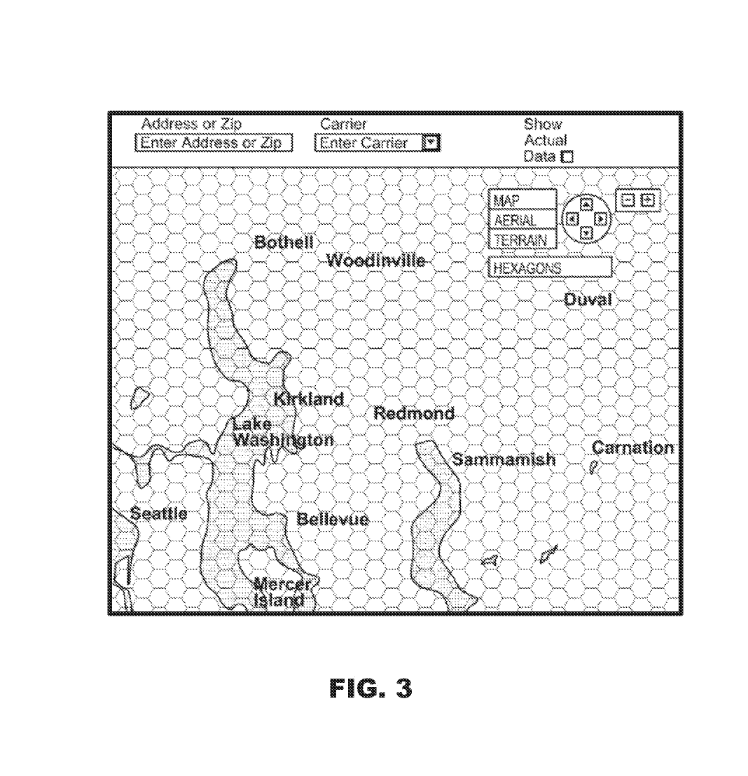

FIG. 3 shows an example map that can be used to visualize quality of service for data communications networks. Paragraphs [0042]-[0153] of U.S. Patent Pub. No. 2012/0038662 describe methods and applications for using maps to visualize data and are hereby incorporated by reference. In addition, maps such as that shown in FIG. 3 can visualize data communication network performance that is based off of measuring actual data transfer rates gathered from a plurality of mobile devices. Maps can show, for a given location, what data transfer speeds users have experienced when using data through a mobile device at a given location.

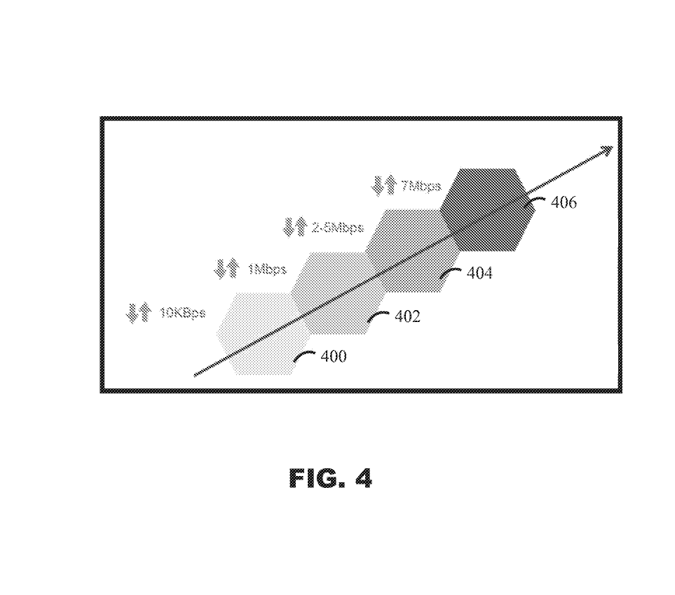

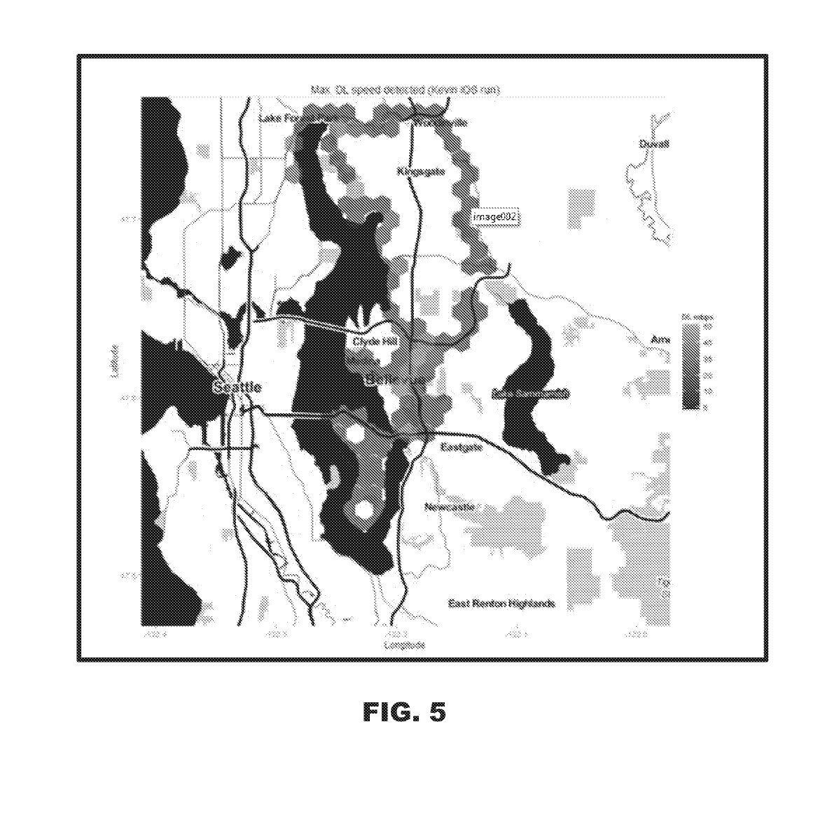

An example of such visualization is shown in FIGS. 4-5, which feature hexagons (e.g., 400, 402, 404, and 406 in FIG. 4) each having a different shading or different. A first hexagon 400 is shaded the lightest and can represent measured data transfer speeds of ˜10 kilobytes/second. Such speeds may be useful for e-mailing applications but not for streaming high-definition. The second hexagon 402 is shaded slightly darker and represents measured data transfer speeds of ˜1 megabytes/second, which may be useful for accessing social media applications, but not for streaming video. The third hexagon 404 is shaded even darker and represents measured data transfer speeds of 2-5 megabytes/second, which may be useful for streaming music applications. The fourth and darkest-shaded hexagon 406 represents measured data transfer rates of at least 7 megabytes/second, which may permit a mobile device to stream high definition video. Each of the hexagons represents real speeds experienced by a mobile device at a given location. Hexagons shaded increasingly darker if a data communications network is able to support increasingly larger data transfer speeds at the location. Mobile device users can use the map and data transfer speed visualization to determine whether certain applications will function as expected at a given location.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A system for identifying data speeds of a wireless communications network as observed by mobile devices provisioned for typical use on the wireless communications networks, the system comprising:
a server configured to:
receive location information of a mobile device,
receive data transfer speed information associated with a plurality of applications of the mobile device, and
in response to receiving the location and data transfer speed information, determine a type of data activity that can be serviced at the location.

2. The system of claim 1, further comprising:
a mobile device provisioned for typical use on the wireless communications network, the mobile device being configure to generate the location information and the data transfer speed information and to send the generated information to the server.

3. The system of claim 2, wherein the mobile device includes:
a plurality of applications that consume data at a data transfer speed when data is transferred to the mobile device over the wireless communications network; and
a data-transfer-measuring application, wherein the data-transfer-measuring application is configured to measure data usage of the plurality of applications without initiating a transfer of data to the mobile device.

4. The system of claim 1, further comprising:
a plurality of mobile devices each generating location information and associated data transfer speed information,
wherein the server is configured to receive location information and associated data transfer speed information from the plurality of mobile devices.

5. The system of claim 4, wherein the server is configured generate a visual indicator of the received data transfer speeds.

6. A method comprising:
receiving data from a plurality of applications operating in the foreground of a mobile device provisioned for typical use on a wireless communications network; and
monitoring, by a second application on the mobile device that is separate from the plurality of applications and running in the background of the mobile device, a data usage rate of the plurality of applications.

7. The method of claim 6, wherein the data usage rate is determined by:
reading a first total data usage value at a first time;
reading a second total data usage value a second time;
calculating a timing interval by subtracting the first time from the second time;
calculating a data usage difference by subtracting the first total usage value from the second total usage value; and
dividing the data usage difference by the timing interval.

8. The method of claim 7, wherein the timing interval is set in response to detecting data usage.

9. The method of claim 8, wherein a shorter timing interval is used in response to detecting data usage.

10. The method of claim 8, wherein a longer timing interval is used in response to detecting no data usage.

11. The method of claim 6, wherein each of the plurality of applications includes a data usage rate reflecting an amount of data transferred to the mobile device by use of an individual application.

12. The method of claim 6, further comprising: storing data usage rates in a memory of the mobile device.

13. The method of claim 6, wherein the second application receives data usage rates without initiating a transfer of data to a mobile device on which the plurality of applications and the second application are stored.

14. The method of claim 6, wherein the received data includes location information indicative of a geographical location of the mobile device, the method further comprising:
measuring data transfer speeds of each of the plurality of applications; and
in response to the received location information and measured data transfer speeds, determining a type of data transfer activity that can be supported by the wireless communication network at the geographical location.

15. A mobile device comprising:
a plurality of data-use applications that receive data at a data transfer speed; and
a data-use-measuring application, wherein the data-use-measuring application is configured to measure data transfer speeds of the plurality of data-use applications without initiating a transfer of data to the mobile device.

16. The mobile device of claim 15, wherein the data-use-measuring application is configured to receive information associated with a location of the mobile device.

17. The mobile device of claim 15, wherein the data-use-measuring application is configured to receive information associated with a type of application being used and related data usage rates of the application.

18. The mobile device of claim 17, wherein the data-use-measuring application is configured to store the location information, data usage information, and type of application in memory.

19. The mobile device of claims 18, wherein the type of application includes one of a music application, video application, social application, and e-mail application.

20. The mobile device of claim 15, wherein the data-use-measuring application is configured to transmit at least one of the following to a server: the location information, the data usage information, the type of application being used information, operating system version information, mobile device model information, network carrier information, and network version information.

21. A system comprising:
a mobile device including a plurality of applications and a data-use-measuring application, wherein the data-use-measuring application is configured to measure data transfer speeds of the plurality of data-use applications without initiating a transfer of data to the mobile device; and
a server configured to receive the data transfer speeds measured by the data-use-measuring application.

22. The system of claim 21, wherein the data-use-measuring application is configured to receive information associated with a location of the mobile device.

23. The system of claim 22, wherein the server is configured to generate a map of data usage rates in response to the received data transfer speeds and the location information.

24. The system of claim 21, wherein the mobile device includes a graphical user interface having an image of a geographical region and a visual representation of data transfer speeds measured from a plurality of applications used on mobile devices located within the geographical region.
